(19) United States
(12) Patent Application Publication
(10) Pub. No.: US 2010/0071851 A1
(43) Pub. Date: Mar. 25, 2010

(54) Channel Roll for Oil Media Pleaters

(75) Inventors: Puenpit RICHBERG, Fayetteville, NC (US); Randy FRYE, Fayetteville, NC (US)

Correspondence Address: CROWELL & MORING LLP;INTELLECTUAL PROPERTY GROUP, P.O. BOX 14300, WASHINGTON, DC, 20044-4300, US

(73) Assignee: PUROLATOR FILTERS NA LLC, Fayetteville, NC (US)

(21) Appl. No.: 12/235,750

(22) Filed: Sep. 23, 2008

(51) Int. Cl. B31F 1/10; F16C 13/00

(52) U.S. Cl. 156/474; 156/199; 492/33; 493/359

(57) ABSTRACT

The present invention relates generally to the manufacture of oil filters. The present invention provides a channel roll with a unique design that minimizes the channel roll surface contact with oil filter media. The design includes the formation of ridges projecting from the surface of the channel roll of such a design that is sufficient to control movement of the roll of oil media into the oil media pleating process, yet greatly reduce the surface contact with the oil media.

### FIELD OF THE INVENTION

The present invention relates generally to the field of oil filters.

### BACKGROUND OF THE INVENTION

Oil filters are commonly used in many of today's machinery, most notably in automobiles and other vehicles, but they are also an essential component in all engines that rely on oil for engine lubrication in maintaining durability and high engine performance. An oil filter relies on an oil media to filter the oil as it circulates through an engine. The oil media is generally a paper-based material where the fibrous content of the material functions to enhance the filtering of particles and hence a cleaning of the oil as it transgresses through the oil media of the filter. In the high volume production of oil filters, it is necessary to run a paper stock forming the oil media through rollers, referred to as channel rolls, arranged as a pair adjacent to one another to order to move the paper stock along the assembly process where different processes are carried out in completing production of the oil filter. Such an arrangement is illustrated in FIG. 1.

One such process is the folding of the paper stock in a certain manner, such as by forming ridges, through a process known as “pleating”. For this step, the channel roll that moves the paper stock is referred to as a pleating roll, as it controls movement of the paper stock prior to the next step of applying the “pleats” into the paper stock for shaping it into a desire pattern or shape arrangement. The current manufacturing process for pleating oil filter media is to have the pleating roll make contact across the full width of the paper stock, that is, from side to side. Disadvantageously, this process significantly crushes the media which compacts the fibers and adversely affects the performance of the media and hence of the oil filter.

### SUMMARY OF THE INVENTION

The present invention overcomes the above described problem by providing a channel roll with a unique design that minimizes the channel roll surface contact with the oil media. The design includes the formation of ridges projecting from the surface of the channel roll of such a design that is sufficient to control movement of the roll of oil media into the oil media pleating process, yet greatly reduce the surface contact with the oil media. By not compacting the oil media fibers, the performance of the filter is enhanced.

### BRIEF DESCRIPTION OF THE DRAWINGS

FIG. 1 shows a sheet of oil filter media being moved and compressed by channel rollers.

FIG. 2 shows an embodiment for a roller projection.

FIG. 3 shows rollers with roller projections added to the surface of a channel roller.

FIG. 4 shows a longitudinal side view of a channel roller with roller projections.

FIG. 5 shows a longitudinal side view of a channel roller with roller projections.

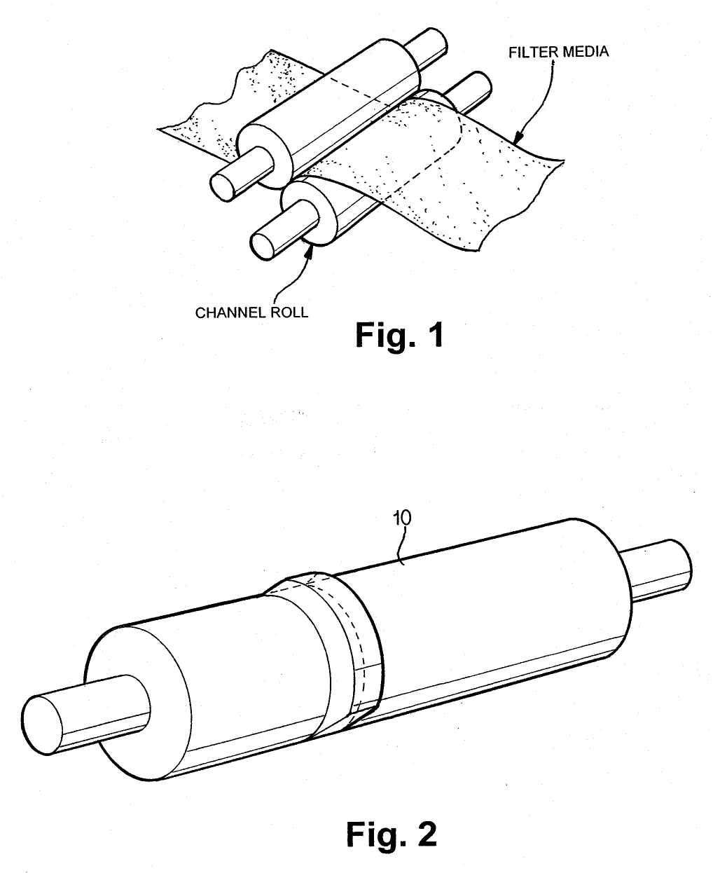

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

The present invention provides a channel roll with a unique design that minimizes the channel roll surface contact with the oil filter media. The design includes the formation of ridges projecting from the surface of the channel roll of such a design that is sufficient to control movement of the roll of oil media into the oil media pleating process, yet greatly reduce the surface contact with the oil media. By not compacting the oil media fibers, the performance of the filter is enhanced.

Referring now to the Figures, FIG. 2 shows channel roll 10 for use in methods of manufacturing oil filters. Channel roll 10 moves oil filter media from a paper roll in the manufacturing process of an oil filter. Roller 12 is affixed onto, or formed as a part of, a roller shaft 14 that is suitable for being used with a power driven assembly (not shown) for moving rotatably about the longitudinal axis of roller shaft 14, thereby imparting the same rotatable movement to channel roll 10.

Projection ridges 16a-c are formed on the outer surface of roller 12. The number of ridges, and the height and width of the ridges, are matters of design choice depending on the specific application or manufacturing process in which the channel roll is to be used. In an embodiment of the invention where the channel roll is used as a pleater roll for oil media pleaters in the manufacturing of an oil filter, the number of projection ridges could be three on channel roll 10, as shown in FIG. 2, with each ridge being ⅛″ wide and ⅛″ in height.

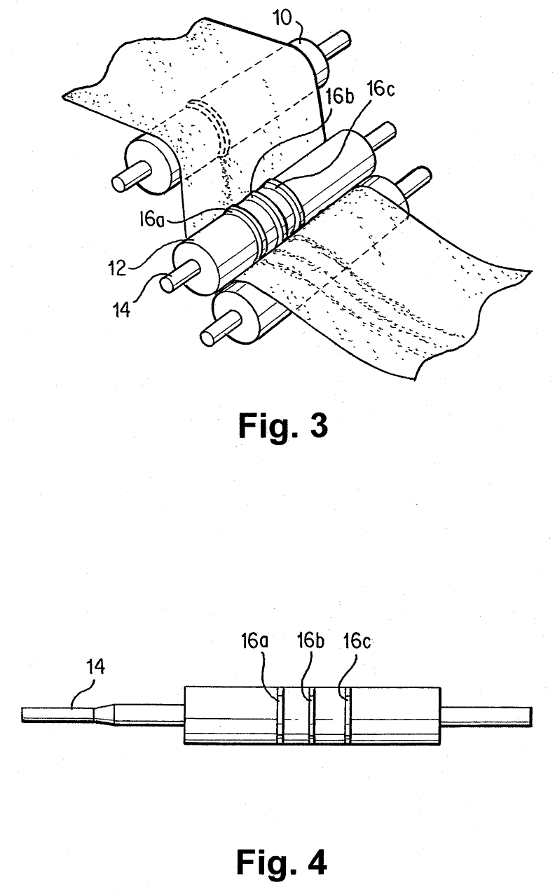

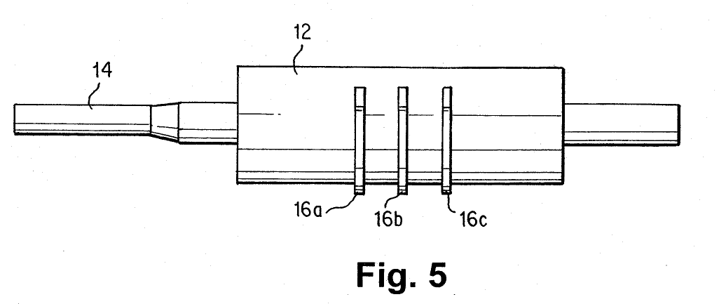

FIG. 3 shows the channel roll of FIG. 2 used as a pleating roll in conjunction with another pleating roll so to form adjacent rolls as a pair for movement of the oil media in a pleating process of an oil filter. The channel roll only contacts the oil media with the ⅛″ wide ribs on the pleating roll. These ribs are the only contact between the oil media and the pleating roll as the oil media is moved through the “pleating” or forming of the oil media into a desired shape. Thus the oil media fibers are not compacted by the pleating roll because the vast majority of the surface of the oil media does not make contact with the roller and hence its fibrous paper-based surface area that is important for carrying out the filtering function remains undisturbed.

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What we claim is:

1. A channel roll for moving a material comprising:
a shaft and a cylindrical roller, the cylindrical roller having an outer surface area formed radially outward at a predetermined distance from said shaft; and
at least one rib formed on the outer surface area of the cylindrical roller for making contact with the material.

2. The channel roll of claim 1, wherein the shaft is adapted for use with a power driven assembly.

3. The channel roll of claim 1, wherein the channel roll comprises at least 2 ribs formed on the outer surface area of the cylindrical roller for making contact with the material.

4. The channel roll of claim 1, wherein the channel roll comprises at least 3 ribs formed on the outer surface area of the cylindrical roller for making contact with the material.

5. A channel roll for oil media pleaters used in the manufacture for an oil filter comprising:
a roller comprising:
a shaft and a cylindrical roller for moving an oil filter media, the cylindrical roller having an outer surface area formed radially outward at a predetermined distance from said shaft; and
at least one rib formed on the outer surface area of the cylindrical roller for making contact with the oil filter media.

6. The channel roll of claim 5, wherein the channel roll comprises at least 2 ribs formed on the outer surface area of the cylindrical roller for making contact with the oil filter media.

7. The channel roll of claim 5, wherein the channel roll comprises at least 3 ribs formed on the outer surface area of the cylindrical roller for making contact with the oil filter media.

8. The channel roll of claim 5, wherein the at least 1 rib formed on the outer surface area of the cylindrical roller for making contact with the oil filter media is about ⅛″ in width.

9. A method of moving oil filter media prior to a pleating process in a manufacture of an oil filter comprising the steps of:
providing a pleating roller having rib projections thereon for moving the oil filter media prior to the pleating process; and
moving the oil media across the pleating roller by having the oil filter media make contact only with an outer surface area of the rib projection.

10. The method of claim 9, wherein the pleating roller comprises at least 2 ribs formed on the outer surface area of the roller for making contact with the oil filter media.

11. The method of claim 9, wherein the pleating roller comprises at least 3 ribs formed on the outer surface area of the roller for making contact with the oil filter media.

12. The method of claim 9, wherein the at least 1 rib formed on the outer surface area of the pleating roller for making contact with the oil filter media is about ⅛″ in width.
